(19) United States
(12) Patent Application Publication
(10) Pub. No.: US 2008/0291692 A1
(43) Pub. Date: Nov. 27, 2008

(54) IMPRESSION-TYPE WRITING BOARD

(75) Inventors: KUN-SHENG KUO, Chu-Nan (TW); CHUAN-FU YANG, Chu-Nan (TW); YUAN-FA CHU, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/048,645

(22) Filed: Mar. 14, 2008

(30) Foreign Application Priority Data
May 25, 2007 (CN) 200710074586.6

(51) Int. Cl. F21V 7/04

(52) U.S. Cl. 362/602; 362/618; 362/622

(57) ABSTRACT

An exemplary writing board includes a deformable thin film, a backlight module, and a light-transmissive film. The thin film has a writing surface and a light incident surface on an opposite side of the thin film to the writing surface. The backlight module is arranged adjacent to the light incident surface and configured for providing light incident onto the light incident surface. The light-transmissive film is arranged between the thin film and the backlight module. A clearance is formed between the light-transmissive film and the thin film, and a distance of the clearance, along a thicknesswise direction of the thin film, is less than or equal to a maximum deformation amount of the thin film at the same direction.

### BACKGROUND

1. Technical Field

The present invention relates to writing boards and, particularly, to an impression-type writing board.

2. Discussion of Related Art

Referring to FIG. 5, an impression-type writing board 30 generally includes a substrate 31, a thin film 32 and a clearance 200 formed therebetween. The substrate 31 usually has a deep color, such as red, different from the thin film 32. The thin film 32 is usually white and disposed on a side of the substrate 31. The thin film 32 includes a first surface 320 facing the substrate 31 and a second surface 322 on an opposite side of the thin film 32 to the first surface 320. The second surface 322 is configured for being written or drawn thereon and receiving outside lights thereon.

When the thin film 32 is in a released state, light emitted on the second surface 322 of the thin film 32 will pass through the thin film 32 and the clearance 200 in sequence, and then reach the substrate 31. After that, light having a color component accordant with the substrate 31 is reflected back via the substrate 31. During the reflected light passing through the clearance 200, the reflected light is diffused and reflected by atmosphere molecules existed in the clearance 200, and therefore an amount of the reflected light that reaches the thin film is visibly decreased. As such, the thin film 32 presents a relatively lighter color than that of the substrate 31. Whereas, when an area of the thin film 32 is in an impressed state resulting from being written or drawn by a pen or the like, a clearance corresponding to the impressed area of the thin film 32 is decreased and whereby less atmosphere molecules are existed. As such, the impressed area shows a relatively deeper color than other released areas due to a reason that the chance of the reflected light being diffused and reflected, by the atmosphere molecules, is reduced. Based upon the above-mentioned principle, characters or images can be displayed on the writing board 30 via being written or drawn by the pen or the like on the thin film 32.

However, the above mentioned writing board only effectively works in environments with abundant outside lights. When lacking of outside lights, the writing board may not function effectively.

Therefore, what is needed is a writing board that can effectively function in environment that lacks of outside lights.

### SUMMARY

A writing board, in accordance with a present embodiment, is provided. The writing board includes a deformable thin film, a backlight module, and a light-transmissive film. The thin film has a writing surface and a light incident surface on an opposite side of the thin film to the writing surface. The backlight module is arranged adjacent to the light incident surface and configured for providing a light incident onto the light incident surface. The light-transmissive film is arranged between the thin film and the backlight module. A clearance is formed between the light-transmissive film and the thin film, and a distance of the clearance, along a thicknesswise direction of the thin film, is less than or equal to a maximum deformation amount of the thin film at the same direction.

Detailed features of the present writing board will become more apparent from the following detailed description and claims, and the accompanying drawings.

### BRIEF DESCRIPTION OF THE DRAWINGS

Many aspects of the present wring board can be better understood with reference to the following drawings. The components in the drawings are not necessarily drawn to scale, the emphasis instead being placed upon clearly illustrating the principles of the present writing board. Moreover, in the drawings, like reference numerals designate corresponding parts throughout the several views, wherein:

FIG. 1 is a schematic, perspective view of a writing board, according to a first exemplary embodiment;

FIG. 2 is a schematic, perspective view of a light guiding plate of the writing board of FIG. 1;

FIG. 3 is a side view of the writing board of FIG. 1, before the writing board being written or drawn by a pen;

FIG. 4 is a side view of the writing board of FIG. 1, after the writing board being written or drawn by a pen; and

FIG. 5 is a schematic, side view of a writing board in the related art.

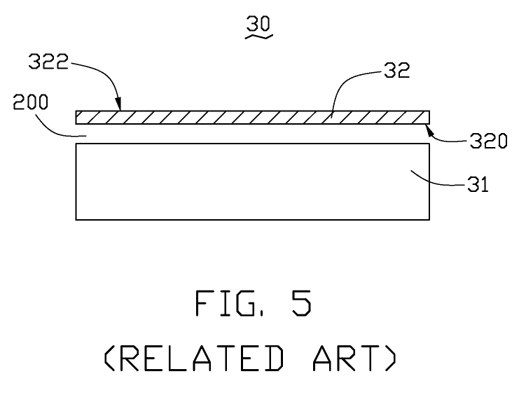

### DETAILED DESCRIPTION OF THE PREFERRED EMBODIMENTS

Reference will now be made to the drawings to describe the embodiments of the present writing board, in detail.

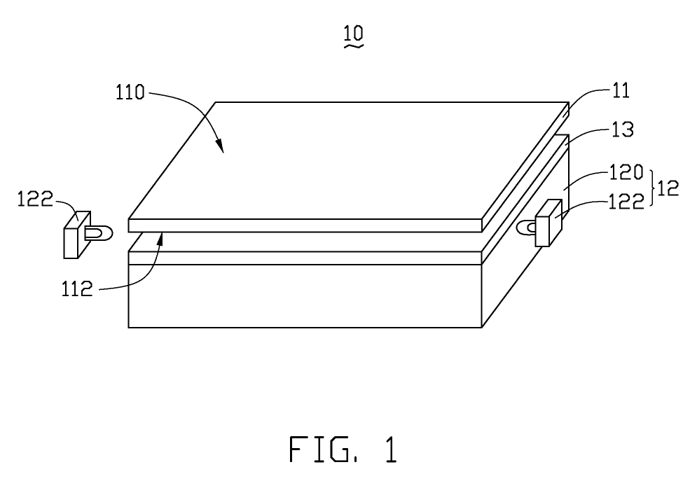

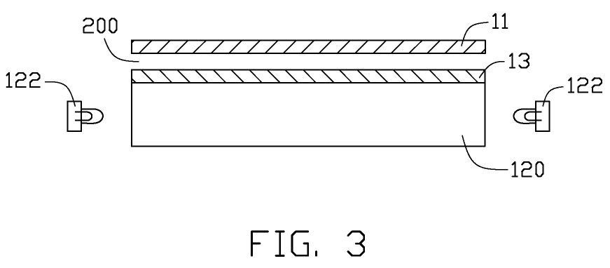

Referring now particularly to FIGS. 1 through 3, a writing board 10, according to a first exemplary embodiment, is provided. The writing board 10 includes a deformable thin film 11, a backlight module 12 and a light-transmissive film 13.

The thin film 11 includes a writing surface 110 and a light incident surface 112 on an opposite side of the thin film 11 to the writing surface 110. The writing surface 110 is configured for being written or drawn thereon. The light incident surface 112 is configured for receiving an incident light provided by the backlight module 12.

The backlight module 12 is arranged adjacent to the light incident surface 112 of the thin film 11. The backlight module 12 is configured for providing light incident onto the light incident surface 112. The backlight module 12 includes a light guiding plate 120 and a light source 122.

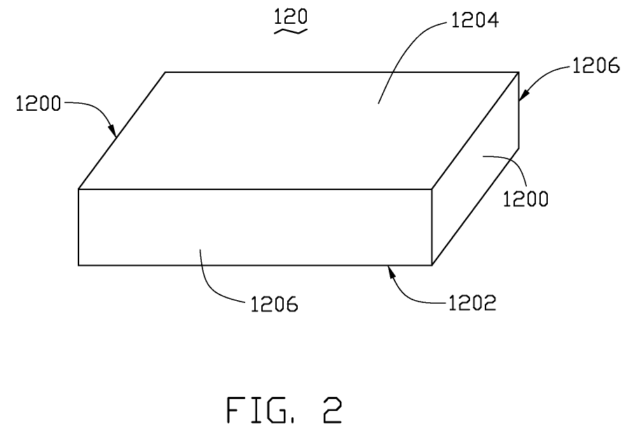

The light guiding plate 120 can be a direct-type light guiding plate or an edge-type light guiding plate. In the exemplary embodiment, the light guiding plate 120 is an edge-type light guiding plate. Referring to FIG. 2, the light guiding plate 120 includes two light incident surfaces 1200, a bottom surface 1202 adjoining the light incident surfaces 1200, a light outputting surface 1204 on an opposite side of the light guiding plate 120 to the bottom surface 1202, and two side surfaces 1206 adjoining the bottom surface 1202. The two light incident surfaces 1200 are located opposite to each other. The bottom surface 1202 beneficially has a plurality of diffusion dots formed thereon. The light outputting surface 1204 is disposed opposite to the light incident surface 112 of the thin film 11. In order to improve light utilization efficiency, the bottom surface 1202 and the side surfaces 1206 can further have a reflective film or a reflective plate formed thereon to reflect lights outputting from the bottom surface 1202 and the side surfaces 1206 back into the light guiding plate 120. The reflected lights will finally output from the light outputting surface 1204. In order to reduce light energy waste, the light incident surface 1200 and the light outputting surface 1204 can further have an anti-reflective film formed thereon. The light guiding plate is 120 suitably made of a material selected from a group consisting of polymethylmethacrylate (PMMA), polycarbonate (PC) and cyclo olefin polymer (COP).

Each of the light sources 122 faces toward the corresponding light incident surfaces 1200 of the light guiding plate 12. The light sources 122 can be selected from a semiconductor light emitting diode or and an organic light emitting diode. In the exemplary embodiment, the light source 122 is semiconductor light emitting diodes. The light source 122 can be a colored light source that can emit red light, green light or blue light.

The light-transmissive film 13 is arranged between the backlight module 12 and the thin film 11, and contact with the light outputting surface 1204 of the light guiding plate 120. A clearance 200 is formed between the light-transmissive film 13 and the thin film 11. A distance of the clearance 200, along a thicknesswise direction of the thin film 11, is less than or equal to a maximum deformation amount of the thin film 11 at the same direction. The light-transmissive film 13 is rather suitably made of plastic. Lights emitted from the light outputting surface 1204 of the light guiding plate 120 will pass through the light-transmissive film 13 to the clearance 200 in sequence, and then reach the thin film 11. During the light passing through the clearance 200, the light is diffused and reflected by atmosphere molecules existed in the clearance 200. Thereby an amount of light that reaches the thin film is visibly decreased, and whole of the writing surface 110 is dimly illuminated.

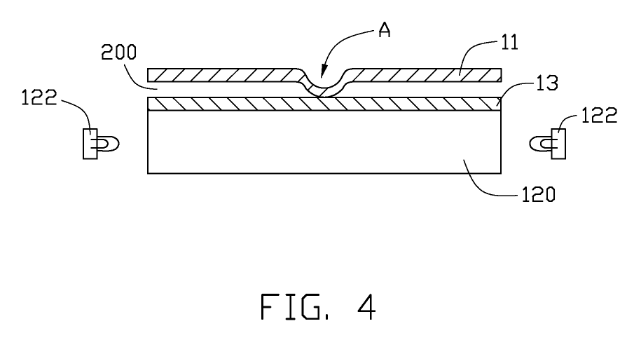

Referring to FIG. 4, after being written or drawn by a pen or the like, pressure generated by a tip of the pen allows the thin film 11 locally contacting and sticking on the light-transmissive film 13 for a period of time, thereby forms an trace area “A”. Lights emitted from the light outputting surface 1204 of the light guiding plate 120 will pass through the light-transmissive film 13 and the thin film 11 without being diffused and reflected by the atmosphere molecules. Thereby, the amount of the lights incident on the trace area “A” of the thin film 11 is more than the amount of light incident on other areas of the thin film 11 that are not pressed by the pen. As such, the trace area “A” of the thin film 11 is brighter than the other areas of the thin film 11 that are not pressed by the pen. As a result, characters or images can be displayed on the writing board 10 in form of trace area “A”.

In sum, due to the writing board 10 is equipped with the backlight module 12, which can provide light incident onto the light incident surface 112 for illumination, the writing board 10 can effectively works with backlight module 12 even though in environments lacking of outside lights.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A writing board, comprising:
a deformable thin film having a writing surface and a light incident surface on an opposite side of the thin film to the writing surface;
a backlight module arranged adjacent to the light incident surface of the thin film and configured for providing light incident onto the light incident surface; and
a light-transmissive film arranged between the thin film and the backlight module;
wherein a clearance is formed between the light-transmissive film and the thin film, and a distance of the clearance, along a thicknesswise direction of the thin film, is less than or equal to a maximum deformation amount of the thin film at the same direction.

2. The writing board according to claim 1, wherein the backlight module comprises a light guiding plate and a light source, the light guiding plate comprises a light incident surface, a bottom surface adjoining the light incident surface and a light outputting surface on an opposite side of the light guiding plate to the bottom surface, the light outputting surface is opposite to the light incident surface of the thin film, and the light source faces toward the light incident surface of the light guiding plate.

3. The writing board according to claim 2, wherein the light-transmissive film is brought into contact with the light outputting surface of the light guiding plate.

4. The writing board according to claim 2, wherein the light guiding plate comprises two opposite light incident surfaces.

5. The writing board according to claim 2, wherein the light guiding plate further comprises a plurality of side surfaces adjoining the bottom surface, and a reflective film or plate formed on each of the side surfaces.

6. The writing board according to claim 2, wherein the light incident surface of the light guiding plate has an anti-reflective film formed thereon.

7. The writing board according to claim 2, wherein the writing board further comprises an anti-reflective film formed between the light outputting surface of the light guiding plate and the light-transmissive film.

8. The writing board according to claim 2, wherein the light source is a colored light source.

9. The writing board according to claim 2, wherein the light source is selected from a group consisting of a semiconductor light emitting diode and an organic light emitting diode.

10. The writing board according to claim 1, wherein the light-transmissive film is made of plastic.

11. A writing board, comprising:
a deformable thin film having a writing surface and a light incident surface on an opposite side of the thin film to the writing surface;
a surface light source module for emitting planar light beams on the light incident surface of the thin film; and
a light-transmissive film arranged between the thin film and the surface light source module; wherein a uniform clearance is formed between the light-transmissive film and the thin film.

12. The writing board according to claim 11, wherein the surface light source module comprises a light guiding plate and a light source, the light guiding plate comprises a light incident surface, and a light outputting surface, the light source facing toward the light incident surface of the light guide plate.

13. The writing board according to claim 12, wherein the light-transmissive film is brought into contact with the light outputting surface of the light guiding plate.
